(19) United States
(12) Patent Application Publication
(10) Pub. No.: US 2010/0228816 A1
(43) Pub. Date: Sep. 9, 2010

(54) SHARING SYSTEM AND MANAGEMENT METHOD FOR HARDWARE DEVICE

(75) Inventors: Jia-Hao Jhou, Taipei (TW); Chang-Yi Shen, Taipei (TW); Ten-Long Dan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/713,189

(22) Filed: Feb. 26, 2010

(30) Foreign Application Priority Data
Mar. 3, 2009 (TW) 98106887

(51) Int. Cl. G06F 9/46; G06F 15/16

(52) U.S. Cl. 709/203; 719/319

(57) ABSTRACT

A sharing system for a hardware device cooperates with a first client host with a first operating system having a hardware driver to generate a management requirement to drive the hardware device. The sharing system according to the invention includes a first server host which may be coupled with a first client host and has a second operating system. The server host may be installed with a pseudo hardware driver to drive the hardware device according to the management requirement generated from the first server host.

### CROSS-REFERENCE TO RELATED APPLICATION

This application claims the priority benefit of Taiwan application serial no. 98106887, filed on Mar. 3, 2009. The entirety of the above-mentioned patent application is hereby incorporated by reference herein and made a part of specification.

### BACKGROUND OF THE INVENTION

1. Field of the Invention

The invention relates to architecture of a sharing system for a hardware device and, more particularly, to architecture of a sharing system for a hardware device across an operating system (OS) platform.

2. Description of the Related Art

In conventional local area network (LAN) architecture, a plurality of clients may share hardware architecture coupled with a server. FIG. 1 is an architecture diagram showing a conventional network sharing system for a hardware device. In FIG. 1, in conventional system architecture 100, a client host 110 may be connected with a server host 130 via a LAN cable 102, and hardware devices such as a printer 150 may be connected with the server host 130 via a transmission interface 142.

In conventional technology, a hardware driver 136 for driving the printer 150 may be installed at a core layer 132 of an operating system of the server host 130. Additionally, an interface driver 138 is installed at the core layer 132 to drive an interface controller 140 at a hardware layer 134 of the server host 130 to manage the transmission interface 142.

A plurality of application software such as a text editor 114 may be installed at an application layer 112 of the operating system. If the user wants to print via the text editor 114, the client host 110 may transmit a print requirement PReq to the server host 130 via a LAN cable 102. The print requirement PReq is transmitted to the hardware driver 136 at the core layer 132 to make the hardware driver 136 call the interface driver 138 to control the interface controller 140 to drive the printer 150 to print via the transmission interface 142.

In the conventional system architecture 100, the hardware driver 136 for driving the printer 150 is installed at the core layer 132 of the operating system of the server host 130. Therefore, the authority of managing the printer 150 needs to be set to the server host 130. If the client host 110 needs to control the printer 150 via the server host 130, the operating system the same as the operating system installed in the server host 130 needs to be installed in the client host 110. In other words, the conventional system architecture 100 cannot permit the client host 110 installed with different operating systems to control the hardware device coupled with the server host 130 via the server host 130.

### BRIEF SUMMARY OF THE INVENTION

The invention provides a sharing system for a hardware device and a management method, which permits a client host having different operating systems to control a hardware device coupled with a server host via the server host.

The invention provides a sharing system for a hardware device, cooperating with a first client host with a first operating system (OS) having a hardware driver to generate a management requirement to drive the hardware device. The sharing system according to the invention includes a first server host coupled with the first client host and having a second operating system. A pseudo hardware driver may be installed at the server host to drive the hardware device according to the management requirement generated from the first server host.

On the other hand, the invention provides a management method for a hardware device adapted for connecting a first client with a server. A first operating system may be installed in the first client, and a second operating system may be installed in the server. The management method according to the invention includes the following aspects. A pseudo hardware driver is installed at the server when the hardware device is coupled with the server via a transmission interface. Additionally, the pseudo hardware driver releases the management requirement to make the management requirement performed at the server when the first client generates a management requirement to manage the hardware device. The server transmits a performing result of the management requirement back to the first client when the management requirement is completely performed at the server.

In some embodiments, when the first client generates the management requirement to manage the hardware device, the hardware device is shielded at the server to make the hardware device regarded as being coupled with the first client.

According to the invention, a driver of the hardware device is installed in the client host, and the management requirements generated from the client host are transmitted to the server host and released by the pseudo hardware driver installed in the server. Consequently, the client hosts with different operating system platforms are permitted to share the hardware device connected with the server host via a server host.

These and other features, aspects and advantages of the present invention will become better understood with regard to the following description, appended claims, and accompanying drawings.

### BRIEF DESCRIPTION OF THE DRAWINGS

FIG. 1 is an architecture diagram showing a conventional network sharing system for a hardware device.

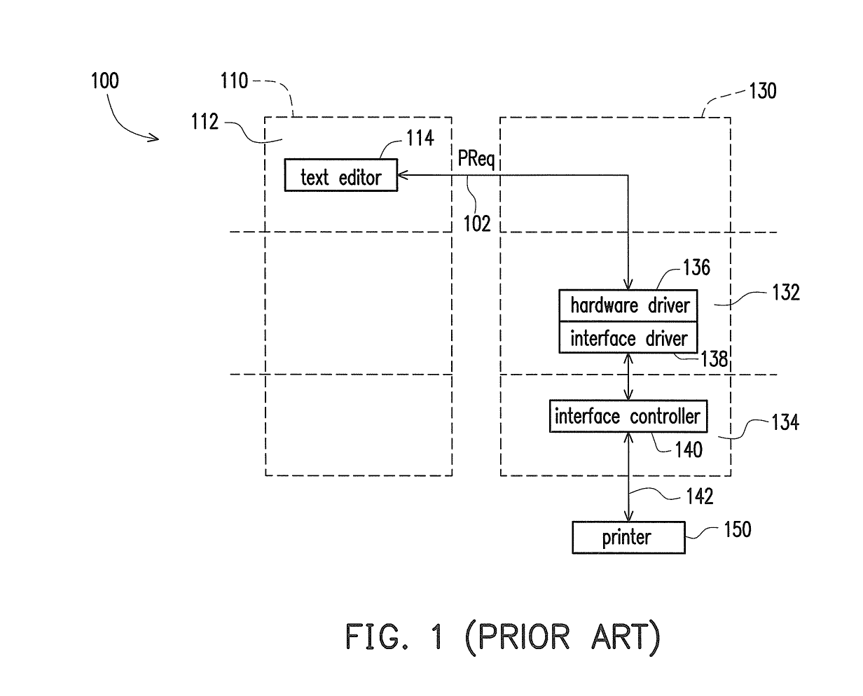

FIG. 2 is a block diagram showing a sharing system for a hardware device according to an embodiment of the invention.

FIG. 3 is a block diagram showing a system including a client host and a server host according to an embodiment of the invention.

FIG. 4 is a flowchart showing a management method for a hardware device according to an embodiment of the invention.

FIG. 5 is a flowchart showing the steps of setting the authority of managing a hardware device to a client host according to an embodiment of the invention.

FIG. 6 is a block diagram showing a sharing system for a hardware device according to another embodiment of the invention.

### DETAILED DESCRIPTION OF THE EMBODIMENTS

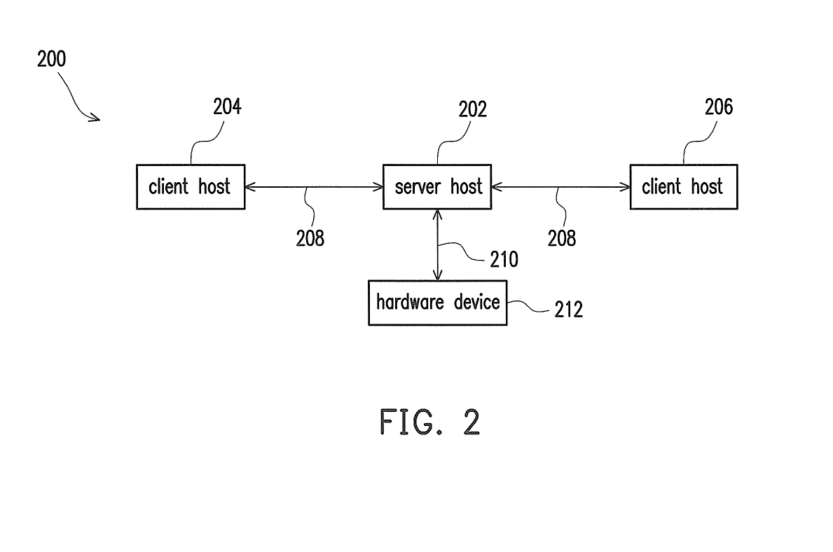

FIG. 2 is a block diagram showing a sharing system for a hardware device according to an embodiment of the invention. In FIG. 2, a sharing system 200 in this embodiment includes a server host 202 which may be coupled with a plurality of client hosts such as client hosts 204 and 206. In this embodiment, the client hosts 204 and 206 may be coupled with a server host 206 via a LAN cable 208, respectively, and they may have corresponding operating systems, respectively. In this embodiment, the client hosts 204 and 206 may have same operating systems or different operating systems.

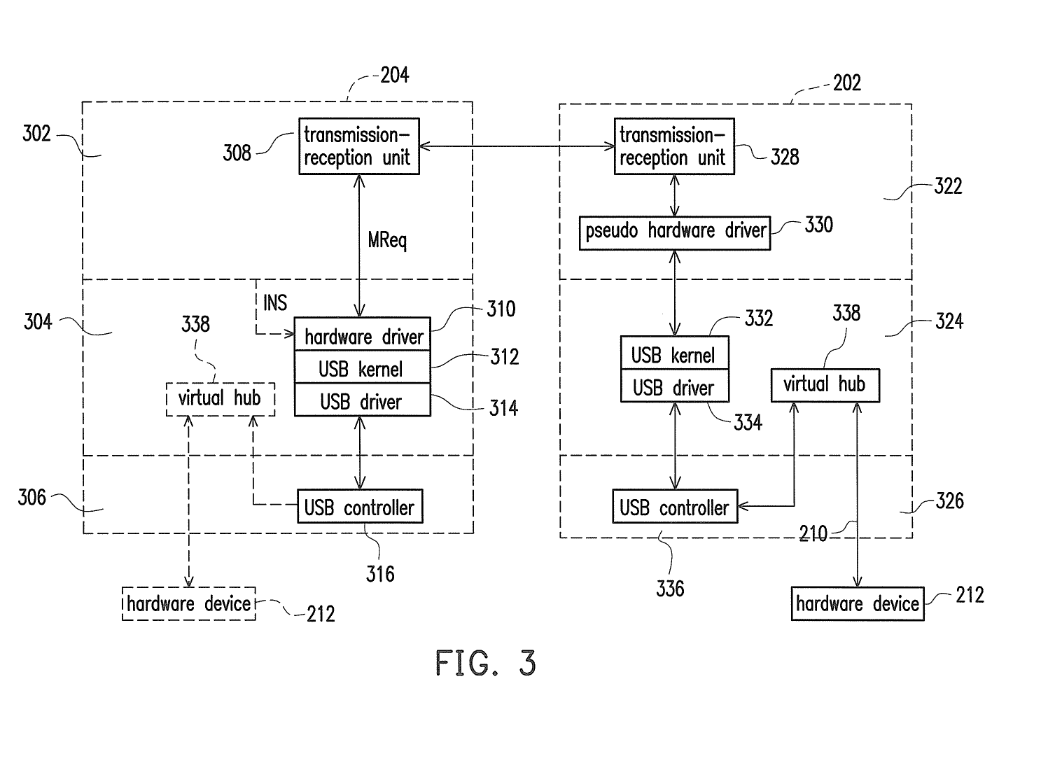

The server host 202 has a transmission interface 210 such as a universal serial bus (USB). The hardware device 212 may be coupled with the server host 202 via the transmission interface 210. FIG. 3 is a block diagram showing a system including a client host and a server host according to an embodiment of the invention. In FIG. 3, in this embodiment, the client host 204 is just taken as an example to illustrate the invention, persons having ordinary skill in the art may infer the system architecture of other client hosts which is not described herein for a concise purpose.

The client host 204 may include an application layer 302, a core layer 304, and a hardware layer 306 of the operating system. A plurality of applications may be installed at the application layer 302, and a transmission-reception unit 308 also may be installed at the application layer 302. In this embodiment, the transmission-reception unit 308 may be realized by software.

A hardware driver 310, a transmission interface kernel 312, and a transmission interface driver 314 are installed at the core layer 304 of the operating system. For a concise purpose, the USB is taken as an example of the transmission interface, but it is not used for limiting the invention.

In the core layer 304, the hardware driver 310 may communicate with the application layer 302, and it may be used for driving the hardware device 212. Additionally, the USB kernel 312 may be taken as an agent between the hardware driver 310 and a USB driver 314. The USB driver 314 may drive a USB controller 316 configured at the hardware layer 306.

Similarly, the server host 202 also may include an application layer 322, a core layer 324, and a hardware layer 326 of the operating system. A transmission-reception unit 328 also may be installed at the application layer 322, and it may be connected with the transmission-reception unit 308. A pseudo hardware driver 330 also may be installed at the application layer 322 of the server host 202, and it may simulate the function similar to that of the hardware driver 310 in the server host 202.

The pseudo hardware driver 330 may be coupled with the core layer 324. The core layer 324 also includes a USB kernel 332 and a USB driver 334. The USB driver 334 is used for driving the USB controller 336 configured in the hardware layer 326.

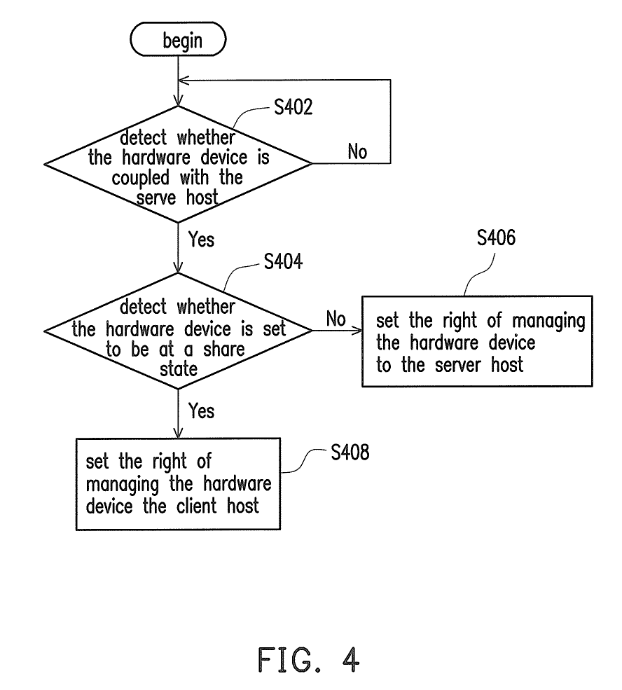

FIG. 4 is a flowchart showing a management method for a hardware device according to an embodiment of the invention. In FIG. 3 and FIG. 4, in this embodiment, the USB controller 336 in the server host 202 may keep monitoring the state of the transmission interface 210 as stated in step 5402. When the hardware device 212 is coupled with the server host 202 via the transmission interface 210, the USB controller 336 may make a response provided to the core layer 324 to make the USB kernel 332 trigger an insertion event, and the information of the insertion event may be transmitted to the client host 204 via the transmission-reception unit 328.

When the transmission-reception unit 308 of the client host 204 receives the information showing that the insertion event is triggered, it may inform the hardware driver 310 installed at the core layer 30. At the time, the hardware driver 310 may generate a corresponding management requirement MReq to the USB kernel 312. Additionally, the management requirement MReq also may be transmitted to the transmission-reception unit 308. At that moment, the transmission-reception unit 308 may convert the format of the management requirement MReq to a proper format to transmit to the server host 202.

When the server host 202 receives the management requirement MReq via the transmission-reception unit 328, it may transmit the management requirement MReq to the pseudo hardware driver 330 to release the management requirement MReq to the core layer 324 of the server host 202 via the pseudo hardware driver 330 to simulate actions of a normal hardware driver. At the time, the USB kernel 332 may process the management requirement MReq. The operating system of the server host 202 and the operating system of the client host 204 may be different. Consequently, when the operating system of the server host 202 and the operating system of the client host 204 are different, the pseudo hardware driver 330 further needs to identify the content of the management requirement MReq and convert the format of the management requirement MReq to a universal format which may be identified in the server host 202, and then it transmits the management requirement MReq to the USB kernel 332.

When the USB kernel 332 receives the management requirement released from the pseudo hardware driver 330, it may call the USB driver 334 to drive the USB controller 336, and it may set a virtual hub 338 at the core layer 324. As a result, the server host 202 may utilize the virtual hub to be connected with the hardware device 212 via the transmission interface 210. Additionally, as stated in step 5404, the USB kernel 332 also may detect whether the state of the hardware device 212 is a share state via the USB controller 336.

If the USB controller 336 detects that the state of the hardware device 212 is not set to be the share state (that is, “No” marked in step S404), the authority of managing the hardware device 212 is set to the server host 202 (S406). On the contrary, if the state of the hardware device 212 is set to be the share state (that is, “Yes” marked in step S404), the authority of managing the hardware device 212 is set to the client host 204 (S408).

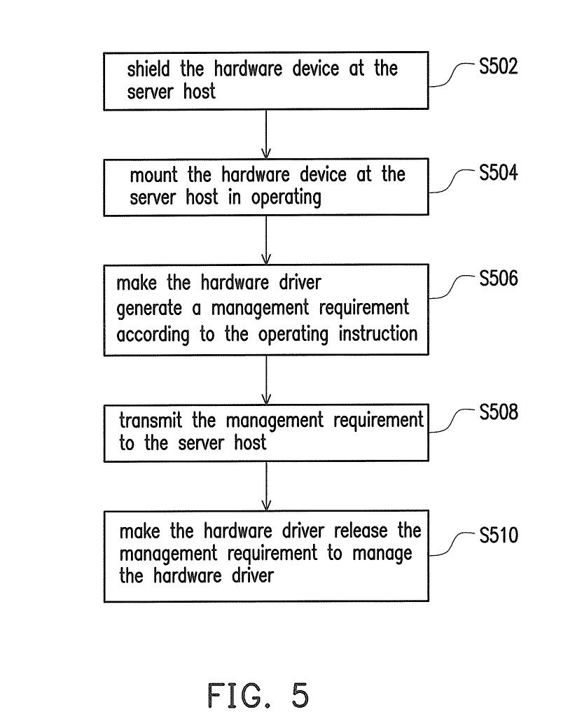

FIG. 5 is a flowchart showing the steps of setting the authority of managing a hardware device to a client host according to an embodiment of the invention. In FIG. 3 and FIG. 4, when the state of the hardware device 212 is detected to be the share state, as stated in step S502, the hardware device 212 is shielded at the server host 202. At that moment, the hardware device 212 is not listed in a hardware list of the server host 202. In other words, the hardware device 212 is regarded as not existing in the server host 202 in operation.

On the other hand, as stated in step S504, the hardware device 212 may be set to be mounted in the client host 204. At the time, the virtual hub 338 may be regarded as existing in the core layer 304 of the client host 204 in operating, and the USB controller 316 may be regarded as being coupled with the hardware device 212 directly via the virtual hub 338. At that moment, the hardware device 212 may be listed in the hardware list of the client host 204. In other words, the hardware device 212 may be regarded as being directly coupled with the client host 204 in operation.

In some embodiments, assuming that the hardware device 212 is an external storage device, when the user wants to access the hardware device 212, the application layer 302 may generate an corresponding operating instruction INS to the hardware driver 310. At that moment, the hardware driver 310 may generate a corresponding management requirement MReq according to the operating instruction INS as stated in step S506. Similarly, as stated in step S508, the management requirement MReq is transmitted to the server host 202 via the transmission-reception unit 308, and thus the transmission-reception unit 328 gives the management requirement MReq to the pseudo hardware driver 330 to release the management requirement MReq as stated in step S510.

When the pseudo hardware driver 330 releases the management requirement MReq generated from the hardware driver 310, the USB kernel 332 controls the USB driver 334 to drive the USB controller 336 to make the USB controller 336 perform the management requirement MReq. For example, when the data needs to be written to the hardware device 212, the data is transmitted to the server host 202. At that moment, the USB controller 336 can control the operation of writing the data to the hardware device 212. When the management requirement MReq is completely performed in the server host 202, the server host 202 may transmit the performing result back to the client host 204 via the transmission-reception unit 328. At that moment, the user at the client host 204 may regard that the operation is finished in the client host 204.

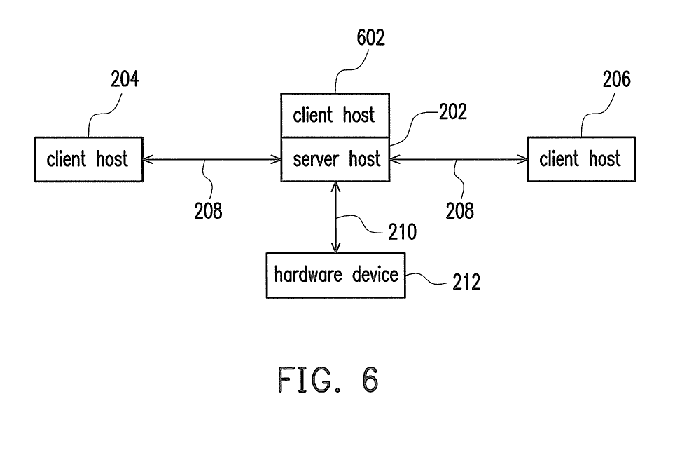

In the above embodiments, the client host 204 and the server host 202 are installed in different computer devices. However, the hardware device 212 does not exist in the server host 202 in operation. Therefore, the user cannot use the hardware device 212 in the computer device having the server host. FIG. 6 is a block diagram showing a sharing system for a hardware device according to another embodiment of the invention. In this embodiment, the server hosts 202 and 602 may be installed at the same computer device. Consequently, the user may use the hardware device 212 in the computer device having the server host 202. In other words, the server host 202 may be realized via any computer device.

To sum up, the driver practically driving the hardware device is installed at each client host, and the server host is installed with the pseudo hardware driver to simulate practical hardware driver. As a result, client computers having different operating systems may be installed with proper hardware drivers, respectively, the generated management requirements may be given to the pseudo hardware driver of the server host to be released and performed at the server host, and thus the hardware device may be shared in the server host.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A sharing system for a hardware device, cooperating with a first client host with a first operating system (OS) having a hardware driver to generate a management requirement to drive the hardware device, the sharing system comprising:
a server host coupled with the first client host and having a second operating system, wherein the hardware device is connected with the server host via a transmission interface, and a pseudo hardware driver is installed at the server host to drive the hardware device according to the management requirement.

2. The sharing system according to claim 1, wherein the transmission interface is a universal serial bus (USB).

3. The sharing system according to claim 1, wherein the first operating system and the second operating system are different.

4. The sharing system according to claim 1, wherein the first operating system comprises:
a first application layer having a first transmission-reception unit for being connected with the server host; and
a first core layer coupled with the first application layer and including:
the hardware driver generating a management requirement to manage and control the hardware device; and
a first transmission interface kernel coupled with the hardware driver to process the management requirement and transmit the management requirement to the transmission-reception unit to convert the format of the management requirement to a predetermined format to transmit to the server host.

5. The sharing system according to claim 4, wherein the second operating system further comprises:
a second application layer having a second transmission-reception unit connected with the first transmission-reception unit, wherein the pseudo hardware driver is installed at the second application layer to receive the management requirement transmitted from the first client host via the second transmission-reception unit; and
a second core layer coupled with the second application layer and including:
a second transmission interface kernel coupled with the pseudo hardware driver to process the management requirement generated by the client host; and
a transmission interface driver coupled with the second transmission interface kernel.

6. The sharing system according to claim 5, wherein the server host further has a transmission interface controller driven by the transmission interface driver according to the management requirement.

7. The sharing system according to claim 6, wherein the second core layer further comprises a virtual hub coupled with the hardware device via the second transmission interface, and the virtual hub is coupled with the transmission interface controller to make the transmission interface controller manage the hardware device via the virtual hub.

8. The sharing system according to claim 1, wherein the first server host and the server host are installed in a same computer device.

9. The sharing system according to claim 1, wherein the first server host and the server host are installed in different computer devices.

10. The sharing system according to claim 1, wherein the client host is connected with the server host via a network.

11. A management method for a hardware device, adapted for connecting a first client with a server, wherein a first operating system is installed in the first client, and a second operating system is installed in the server, the management method comprising:
when the hardware device is coupled with the server via a transmission interface, installing a pseudo hardware driver at the server; and
when the first client generates a management requirement to manage the hardware device, releasing the management requirement by the pseudo hardware driver to make the management requirement performed at the server; and
transmitting a performing result of the management requirement back to the first client by the server.

12. The management method according to claim 11, wherein when the first client generates a management requirement to manage the hardware device, the hardware device is shielded at the server to make the hardware device regarded as being coupled with the first client.

13. The management method according to claim 11, wherein the transmission interface is a USB.

14. The management method according to claim 11, wherein the first operating system and the second operating system are different.

15. The management method according to claim 11, wherein the first client and the server are in a same computer device.

16. The management method according to claim 11, wherein the first client and the server are in different computer devices.
